(19) United States
(12) Patent Application Publication
(10) Pub. No.: US 2004/0043224 A1
(43) Pub. Date: Mar. 4, 2004

(54) Enhanced hydrophobic membranes and methods for making such membranes

(76) Inventor: Shmuel Sternberg, Palatine, IL (US)

Correspondence Address: Baxter Healthcare Corporation, Fenwal Division, RLP-30, Route 120 & Wilson Road, P.O. Box 490, Round Lake, IL, 60073, US

(21) Appl. No.: 10/232,083

(22) Filed: Aug. 30, 2002

(51) Int. Cl. B32B 27/00

(52) U.S. Cl. 428/421; 428/514

(57) ABSTRACT

Enhanced hydrophobic membranes and methods of making such membranes are disclosed. The membranes are made of a polymer, such as polyvinylidene difluoride coated with a fluorochemical acrylate polymer to enhance hydrophobicity. Membranes of the type described above are made without cross-linking, grafting or in situ polymerization.

The present invention generally relates to membranes with enhanced hydrophobicity and methods for making such membranes. More particularly, the present invention relates to membranes with enhanced hydrophobicity that do not require cross-linking, grafting, in situ polymerization, or other extraordinary treatments, commonly used to make such membranes.

### BACKGROUND OF THE INVENTION

Membranes with enhanced hydrophobic properties are well known in the art. U.S. Pat. No. 5,217,802 and U.S. Pat. No. 5,554,414 describe membranes that are both hydrophobic and oleophobic. The membranes described therein are formed from a porous polymeric substrate having its entire surface modified with a cross-linked polymer. The cross-linked, polymer is formed in situ on the polymeric substrate from a reactant system that includes a monomer and a polymerization initiator dissolved in a polar solvent system. The substrate is exposed to a suitable energy source to effect the polymerization and the cross-linking of the monomer at the surface of the membrane.

Membranes that are coated with a hydrophobic (and oleophobic) coating are also known. One example of a coated membrane is described in U.S. Pat. No. 5,342,434. U.S. Pat. No. 5,342,434 discloses a gas-permeable coated porous membrane. The porous membrane is made of a polymeric material coated with a solution that is a reaction product of a perfluoroalkyl alcohol compound with a selected diisocyanate. The membrane described therein is useful in repelling oils, automotive fluids, alcohols and the like. The membrane is cured by oven heating.

U.S. Pat. No. 5,462,586 discloses a water and oil repellent, gas-permeable filter. The filter membrane is made of polytetrafluoroethylene (PTFE) and is coated with a blend or a combination of two fluorinated polymers. One polymer is obtained by the cyclic polymerization of fluorine containing monomers. The other fluoropolymer is a homopolymer obtained by radical polymerization of an alpha, beta-unsaturated monomer containing at least one polyfluoralkyl group. Examples of the latter include acrylic and methaacrylate monomers. The coating solution made of the two fluoropolymers can be applied to the porous, gas-permeable material and then dried by heating between 50° C. and 200° C.

One drawback with some of the known membranes is that they require additional steps, such as cross-linking, grafting or in situ polymerization. With respect to membranes that may not require cross-linking, grafting or in situ polymerization, as described in U.S. Pat. No. 5,462,586, the coating solution utilizes two different fluoropolymers, thus, adding expense to the manufacture of the membrane.

It would be desirable to provide a gas-permeable, enhanced hydrophobic membrane that does not require these additional treatment steps and that can be more simply made, and yet exhibit an enhanced hydrophobicity that makes the membrane suitable for use in many applications, such as, but not limited to, use in the medical field.

### SUMMARY

In one aspect, the present invention is directed to an, enhanced hydrophobic, gas-permeable, biocompatible membrane. The membrane includes a substrate, a membrane formed on the substrate wherein the membrane is a hydrophobic fluorinated polymer. A fluorochemical acrylate coating is applied to the membrane, wherein the coating is applied as a solution substantially without cross-linking or grafting.

In a more particular aspect, the membrane may be an alloy membrane of polyvinylidene difluoride and an acrylate polymer.

In another aspect, the present invention is directed to a method for making an enhanced hydrophobic, gas-permeable, biocompatible membrane. The method includes providing a substrate comprising a sheet of a polymeric material, forming a hydrophobic membrane by contacting the substrate with a solution comprising a polymeric material, such as polyvinylidene difluoride. The method further includes contacting the substrate and solution with a non-solvent for the fluorinated polymer to form the membrane, and subsequently drying the membrane. The method also includes enhancing the hydrophobicity of the membrane by contacting it with a coating of a hydrophobic composition consisting essentially of a fluorochemical acrylate polymer.

In another aspect, the present invention is directed to an intravenous liquid administration system. The system includes a source of intravenous fluid, a tube defining a flow path from the intravenous solution source to a patient wherein the flow path includes a flow through filter located between the fluid source and the patient. The filter includes a vent that comprises a biocompatible membrane formed of a hydrophobic fluorinated polymer including a coating applied to the membrane, the coating being a polymeric solution consisting essentially of a fluorochemical acrylate polymer. The membrane is made substantially without cross-linking or grafting.

### BRIEF DESCRIPTION OF THE DRAWINGS

FIG. 1 is a diagram showing the method of making the enhanced hydrophobic membrane embodying the present invention;

FIG. 2 is a plan view of a biological fluid processing set, such as an intravenous fluid administration set, incorporating a membrane embodying the present invention.

FIG. 3 is a cross-sectional side view of a filter with a membrane embodying the present invention; and

FIG. 4 is a perspective view of an exemplary membrane embodying the present invention.

### DETAILED DESCRIPTION

In one embodiment, membranes of the present invention may be flat sheet, porous membranes. Turning first to FIG. 4., there is shown, in one-non-limiting example, a membrane cut in the shape of a disk for use as a vent in a filter of an intravenous fluid administration set (described below). Membrane 10 may include one or more layers of a polymeric material that includes, for example, polyvinylidene difluoride (PVDF), polytetrafluoroethylene (PTFE) or other suitable polymer. The layers may be made entirely of the polymer or may be made of a blend of, for example, PVDF and other suitable polymers and copolymers. (As used herein, the term “PVDF membrane” or “PVDF layer” encompasses membranes or layers made entirely of PVDF and/or blends of PVDF with other polymers and/or copolymers.)

Although many of the fluorinated polymers such as PVDF or PTFE are known to be hydrophobic, in accordance with the present invention, the hydrophobicity of such polymers may be enhanced, as described in greater detail below. Thus, the surfaces of fluoropolymer membrane are typically treated with a hydrophobic coating.

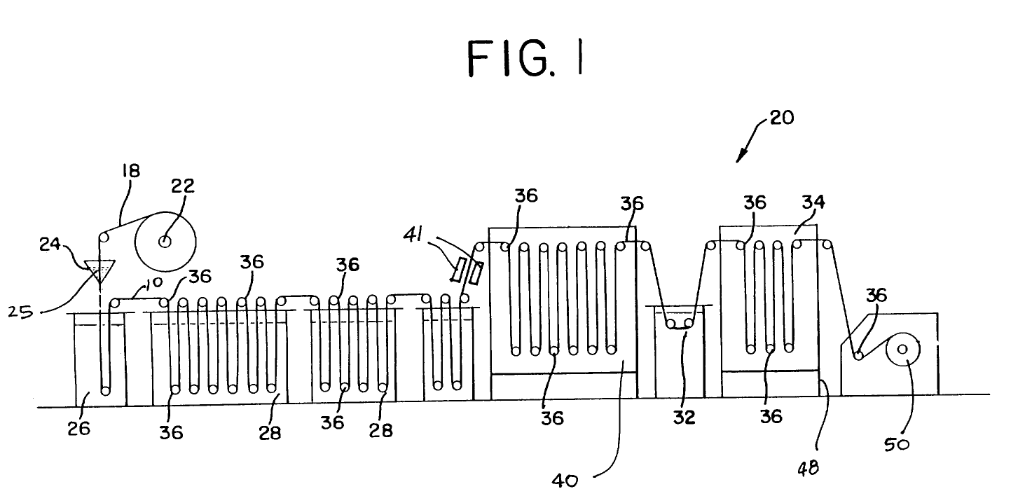

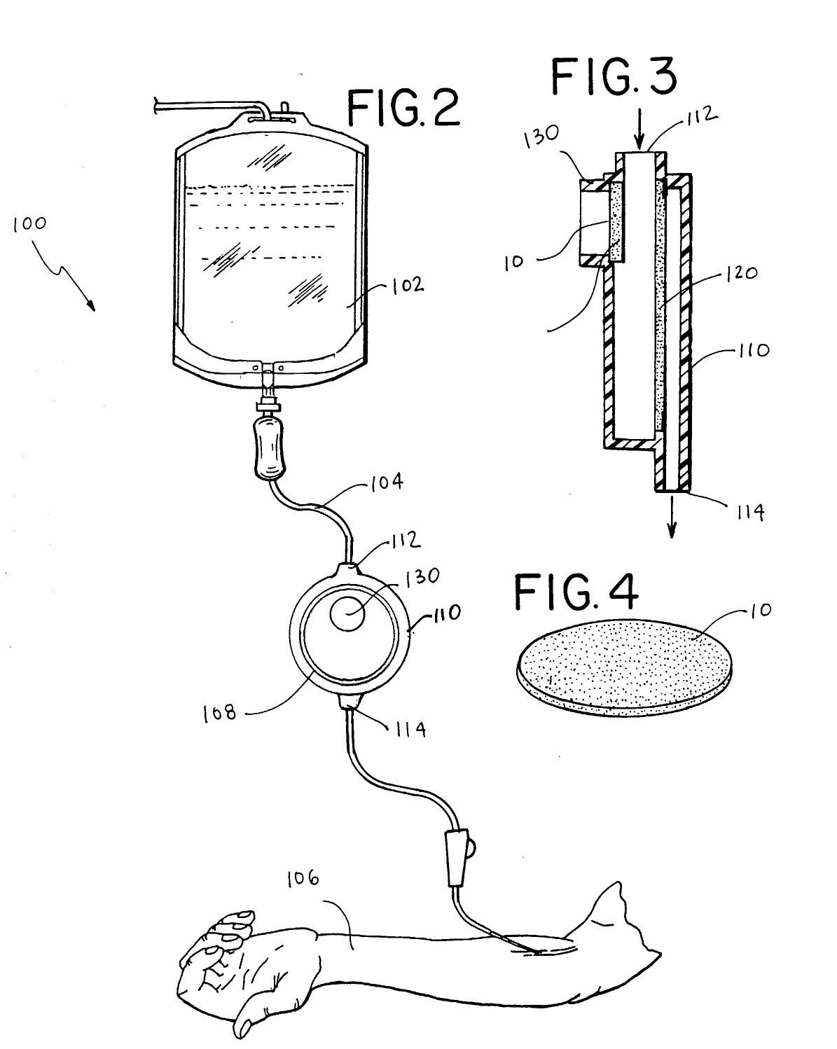

As shown generally in FIG. 1, membrane 10 may be used in association with (and made with) an internal support 18, typically made of a fibrous, porous polymeric material such as polyester mesh, onto which one (or more) layer(s) of the polymer (e.g., PVDF) is applied to form the membrane.

In one example, membranes (with the internal support) may have a thickness of approximately 4-7 mils or approximately 0.004-0.007 inches. Typically, the membranes are substantially isotropic but may also be anisotropic (i.e., where the pore size changes from one surface of the membrane to the other). Membranes made in accordance with the present invention may be “microporous” membranes, having a nominal pore size of less than about 100 microns and typically between approximately 0.01-10 microns. In addition, membranes made in accordance with the present invention may be “ultrafiltration” membranes, having a nominal pore size of less than approximately 0.01 microns. In one example, the microporous membrane may have a nominal pore size of approximately 0.2-1.2 microns. More typically, the nominal pore size of the membrane may be no less than approximately 0.8 microns.

Suitable polymers for making the membrane, such as the preferred PVDF, are available from many different sources such as Elf Atochem of Philadelphia, Pa. In accordance with a preferred embodiment, prior to forming membrane, the polymer is typically dissolved in a suitable solvent. A suitable solvent for PVDF is dimethylacetamide (DMAC), although other solvents may also be used. In one embodiment, approximately 18-22° C., by weight, of PVDF is dissolved in DMAC to provide a PVDF solution. Preferably, this PVDF solution is maintained (“cured”) for approximately 18 hours at between 28-35° C. and more preferably, approximately 31° C. prior to forming the membrane. Of course, where other polymeric materials are used, different solvents, different curing times and temperatures may be used.

Membranes of the type described above may be made by flowcasting or extrusion. FIG. 1 illustrates one method and the associated apparatus for making a membrane of the present invention. The method depicted in FIG. 1 is commonly known as a flow-casting method in which the membrane is formed continuously on a moving support surface 18 such as a web or belt made of a suitable material. It will be understood, however, that in its broader aspects, the present invention is not limited to the particular method employed in making the membrane or the presence or absence of a support surface. For example, PVDF membranes without the support, as shown in FIG. 1, may be made by applying the PVDF to a drum and thereafter peeling the membrane off the surface of the drum. Alternatively, PVDF membranes may be made by casting a PVDF solution onto a support of the type described above, forming the membrane and then separating the membrane from the support, as described in U.S. Pat. No. 4,203,848, which is incorporated by reference herein.

As shown in FIG. 1, the web or support 18 is dispensed from supply roll 22 into a V-shaped trough or chamber 24 that is filled with the cured PVDF solution 25 (described above). As support 18 passes through chamber 24, the PVDF solution is applied to the outer surfaces of the support web 18. (It will be understood that optionally, only one side of the support may be coated with the PVDF solution.) The support, with the PVDF solution applied thereon, exits the chamber through an opening at the bottom of the chamber 24. As shown in FIG. 1, apparatus includes a series of rollers 36 over which the support is threaded as generally shown. Rotation of rollers 36 effects movement of the support 18 from dispenser 22 through the series of baths and drying devices, which are described in more detail below. The rate of movement of support 18 may depend on the required or desired residence times of the support (with the membrane applied thereon) within the baths and drying devices. In one non-limiting example, the rate of movement may be between approximately 1-5 ft/min and, more typically, approximately 3 ft/min.

The coated support 18 then passes through a first coagulation bath 26. Typically, the first coagulation bath 26 holds a liquid or solution which is a non-solvent for the polymer (e.g., PVDF) portion of the casting solution, but is freely miscible with the solvent portion (e.g., DMAC) of the solution. An example of the liquid in coagulation bath 26 is a solution that includes methanol. Contact with the liquid in the coagulation bath 26 coagulates the polymer solids (e.g., PVDF) and extracts the solvent portion (i.e., DMAC) from the applied layer of the polymer, thereby forming a porous membrane on the support. An example of such a “solvent/non solvent” method of forming membranes is described in, for example, U.S. Pat. No. 3,642,668, which is incorporated by reference herein.

The support 18 with the polymeric membrane on its surface is then advanced from coagulation bath 26 to one or more extraction baths 28. Typically, the extraction bath(s) will contain a liquid that extracts any residual solvent (e.g., DMAC), which was used to dissolve the polymer, from the membrane. In a preferred embodiment, the liquid may be water. Depending on the type and strength of the solvent used, the membrane may undergo a series of wash steps in one or more extraction baths 28, each bath further washing and removing solvent from the membrane. For purposes of example only, three extraction baths 28 are shown in FIG. 2.

Once the solvent has been substantially extracted from the membrane, the membrane is dried. Various drying techniques may be used. For example, after the final extraction bath, the membrane may be introduced into a drying oven 40 shown in FIG. 1. Alternatively, and perhaps more preferably, the membrane may be dried by contacting the membrane sheet with one or more heated drums, which dry the membrane.

In one embodiment, where drying oven 40 is used, a drying temperature of approximately 65° C. or less may be sufficient to thoroughly dry the membrane. Alternatively, where a series of heated drums are used, the temperature of the first drum may be higher than the temperature of the later drums in the series to allow substantially all of the water to be evaporated from the wet membrane. The later drums, which are set at a lower temperature (such as, but not limited to, 50° C. to 60° C.), ensure that the membrane is completely dry. Regardless of the drying apparatus used, excess water may also be removed from the membrane by passing the membrane between wipers 41 prior to drying, as generally depicted in FIG. 1.

Continuing with a description of the method for making membranes of the present invention, with reference to FIG. 1, the dry membrane is then immersed in or otherwise contacted with the coating solution including a suitable hydrophobic polymeric solution. One particularly preferred polymer is a fluorochemical acrylate polymer. Examples of fluorochemical acrylate polymers that may be used are provided in U.S. Patent Application Publication No. US 2002/0042470, incorporated herein by reference. Other fluorinated acrylate polymers may also be used.

The fluorochemical acrylate polymer may be carried in any suitable solvent. In one embodiment, the hydrophobic polymeric coating solution is a fluorochemical acrylate polymer carried in a solvent system including, for example, a hydrofluoroether. In one embodiment, the fluorochemical acrylate polymer is carried in a solvent system that includes methyl nonafluoroisobutyl ether and methyl nonafluorobutyl ether. In one embodiment, approximately 1-3%, by weight, of the fluorochemical acrylate polymer may be carried in a solvent system that includes between approximately 20-80%, by weight, methyl nonafluoroisobutyl ether and 20-80%, by weight, methyl nonafluorobutyl ether. A suitable polymeric coating solution of the type described above is available from the 3M Company of St. Paul, Minn., under the name NOVEC EGC-1700. Of course, other hydrophobic coating solutions may also be used in the present invention.

In another embodiment, where the membrane is made of PVDF, the coating solution in bath 44 may include the aforementioned fluorochemical acrylate polymer with a selected amount of an additional solvent. The fluorochemical acrylate polymer with the additional solvent, when placed into contact with the formed PVDF membrane, “blends” with the PVDF and results in an alloy of the acrylate polymer and the underlying PVDF membrane. An alloy membrane of the type described above requires a suitable solvent and one that is less volatile than the original solvent system of the acrylate polymer. One such solvent may be dimethylacetamide (DMAC), which is both a solvent for the acrylate polymer and, for example, PVDF. Other suitable solvents may include N-methylpyrrolidone (NMP), dimethylformamide (DMF), dimethylsulfoxide (DMSO), or other aprotic solvents. DMAC or other suitable solvent may be added to the fluorochemical acrylate polymer in a ratio of approximately 1:1 to 3:1 solvent to polymer. Thus, for example, if the coating solution includes approximately 1% of the acrylate polymer, adding approximately 1% DMAC (or other suitable solvent) will result in 1:1 ratio of solvent to polymer.

Upon contact with the PVDF, it is presently understood that the fluorochemical acrylate polymer (in DMAC) will blend with the PVDF and result in the formation of an alloy membrane of PVDF and the acrylate polymer with its own unique properties (e.g., melting point) that are different than the individual properties of the individual alloy components. It is further believed that the PVDF-acrylate alloy membrane serves to more firmly anchor the acrylate polymer to the membrane, resulting in a more permanent coating. In short, membranes comprising an alloy of PVDF and fluorochemical acrylate polymer are desirable because the membrane surface is less subject to extraction.

After coating with the hydrophobic solution, the membrane may be further dried by simple air drying or drying in another drying apparatus such as oven 48, which dries the membrane as described above in connection with the membrane prior to wetting. In the case of an alloy membrane of the type described above, drying may also help evaporate residual solvent and help form the alloy. After drying, the membrane may be cut (to its desired width or shape) and accumulated on take-up roll 50. The membrane may be further cut into smaller lengths or shapes, as necessary.

Membranes of the present invention may find particular use in the medical field. For example, the membrane of the present invention may find particular application in the area of processing of biological fluids such as blood and, more particularly, in blood apheresis systems which utilize vents for removing air from the systems. Likewise, membranes of the present invention may also find use in intravenous liquid administration to a patient. Intravenous (IV) liquid administration is typically accomplished with a disposable processing set 100 of the type generally shown in FIG. 2.

As shown in FIG. 2, the set 100 includes a source of an intravenous fluid 102, a tube 104 defining a flow path from the source 102 to a patient 106. IV sets of the type shown in FIG. 2 also typically include an in-line filter 108, to remove (by filtering) undesirable particulate matter and potentially harmful microorganisms. Filter 108 may include a housing 110 with an inlet port 112 and outlet port 114. The housing may be constructed from any material which is biocompatible and amenable to sterilization by forms of sterilization typically used for medical products.

Filter 108 also includes a hydrophilic membrane 120 enclosed within housing 110. To allow flow through filter 108, inlet and outlet ports 112 and 114 are typically located on opposite sides of the membrane 120. As mentioned above, membrane 120 is hydrophilic and, therefore, allows liquid entering through inlet 112 to pass through membrane 120 and out through exit port 114.

To ensure that gas or air suspended or entrained in the fluid is also removed, and to eliminate or reduce the risk of embolism from air or gas reaching the patient, it is also desirable to provide a vent 130 that can remove such air or gas. Vent 130 is generally shown in FIG. 2. Vents for removing air may, preferably, include hydrophobic membranes 10 made in accordance with the present invention.

The hydrophobic membrane 10 of the present invention will not be wet by the aqueous intravenous liquid. It will, however, allow air and gas to pass through, thereby reducing the risk of air bubbles and/or embolism. Membrane 10 retains its hydrophobic quality for at least 96 hours. Alloyed membranes of the type described above may retain hydrophobicity even longer.

Membranes of the present invention have a surface tension of less than 25 dynes/cm, more typically less than 20 dynes/cm, and most preferably a surface tension of 15 dynes/cm or less. Thus, membranes of the present invention are effective in repelling most solutions that are at least partially aqueous.

Although described in the context of an intravenous fluid administration, membranes made in accordance with the present invention are not limited to use in the medical fluid or to use with aqueous based solutions. Membranes of the present invention may also be used in the processing of organic liquids such as gasoline, oils and the like (where venting may also be desired). Membranes made of alloyed polyvinlyidene difluoride and acrylate polymer of the type described above are believed to be particularly effective in repelling such organic liquids.

While the present invention has been described in the context of its preferred uses and preferred methods of manufacture, it will be understood that the present invention is not limited to the same, and that further modifications to the methods and membranes described above are included within the scope of the appended claims.

What is claimed:

1. An enhanced hydrophobic, gas-permeable, biocompatible membrane comprising:
a substrate;
a membrane formed on said substrate, said membrane comprising a fluorinated hydrophobic polymer;
a coating consisting essentially of a fluorochemical acrylate polymer on said membrane, wherein said coating is applied to said membrane as a polymeric solution substantially without cross-linking or grafting.

2. The membrane of claim 1 wherein said hydrophobic polymer is selected from the group consisting of polyvinylidene difluoride and polytetrafluoroethylene.

3. The membrane of claim 1 wherein said coating comprises a solution between approximately 1%-3%, by weight, of a fluorochemical acrylate polymer and a solvent.

4. The membrane of claim 3 wherein said solvent comprises a methyl nonafluoroisobutyl ether and methyl nonafluorobutyl ether.

5. The membrane of claim 4 wherein said solvent comprises approximately 20-80%, by weight, methyl nonafluoroisobutyl ether and between approximately 20-80%, by weight, methyl nonafluoroisobutyl ether.

6. The membrane of claim 1 having a surface tension of less than 15 dynes/cm.

7. An enhanced hydrophobic, gas permeable, biocompatible membrane comprising:
a substrate;
a membrane formed on said substrate, said membrane comprising an alloy of blended vinylidene difluoride and acrylate polymers.

8. A method for making an enhanced hydrophobic, gas-permeable, biocompatible membrane comprising:
providing a substrate comprising a sheet of a polymeric material;
contacting said substrate with a solution comprising a hydrophobic polymer;
contacting said substrate and said solution with a non-solvent for the hydrophobic polymer to form said membrane;
enhancing the hydrophobicity of said membrane by contacting said membrane with a coating of a hydrophobic composition consisting essentially of a fluorochemical acrylate polymer.

9. The method of claim 8 further comprising drying said membrane.

10. The method of claim 9 wherein said fluorochemical acrylate polymer is carried in a solvent selected from the group consisting of DMAC, NMP, DMF and DMSO.

11. The method of claim 8 further comprising drying said membrane after contacting with said fluorochemical acrylate polymer.

12. An intravenous fluid administration system comprising:
a source of an intravenous fluid;
a tube defining a flow path from said intravenous solution source to a patient, said flow path including a flow-through filter located between said patient and said fluid source;
said filter comprising a vent including an enhanced hydrophobic, gas-permeable, biocompatible membrane formed of a hydrophobic polymer and a coating consisting essentially of a fluorochemical acrylate polymer applied to said membrane as a polymeric solution substantially without cross-linking or grafting.

13. The intravenous administration set of claim 12 wherein said hydrophobic polymer is selected from the group consisting of polyvinylidene difluoride and polytetrafluoroethylene.

14. The intravenous administration set of claim 12 wherein said coating comprises a solution of a fluorochemical carnality polymer and a solvent.

15. The intravenous administration set of claim 12 wherein said solvent comprises a methyl nonafluoroisobutyl ether and methyl nonafluorobutyl ether.

16. The intravenous administration set of claim 15 wherein said solvent comprises approximately 20-80%, by weight, methyl nonafluoroisobutyl ether and between approximately 20-80%, by weight, of methyl nonafluoroisobutyl ether.

17. The intravenous administration set of claim 12 having a surface tension of less than 15 dynes/cm.

18. The intravenous administration set of claim 12 wherein said hydrophobic polymer is polyvinylidene difluoride and said membrane comprises an alloy of said polyvinylidene difluoride and said fluorochemical acrylate polymer.
